(19) United States
(12) Patent Application Publication
(10) Pub. No.: US 2016/0080267 A1
(43) Pub. Date: Mar. 17, 2016

(54) MONITORING DEVICE, SERVER, MONITORING SYSTEM, MONITORING METHOD AND PROGRAM RECORDING MEDIUM

(71) Applicant: NEC Corporation, Tokyo (JP)

(72) Inventor: Yoshihiro OKADA, Tokyo (JP)

(73) Assignee: NEC Corporation

(21) Appl. No.: 14/826,728

(22) Filed: Aug. 14, 2015

(30) Foreign Application Priority Data
Sep. 12, 2014 (JP) 2014-185981

(51) Int. Cl. H04L 12/803; H04L 12/26

(52) U.S. Cl. CPC H04L 47/125; H04L 43/10

(57) ABSTRACT

Disclosed is a monitoring device etc. which can carry out server load control in the light of the relationship between contents and load fluctuation, configured to monitor one or more servers which perform a processing in response to a request from a client, and transmit a reply to the client, the monitoring device including an operating plan unit which generates an operating plan of carrying out server load control depending on matter-of-interest information or depending on time information, based on access information related to the request and based on a request analysis result obtained by analyzing the request, the access information and the request analysis result being collected from the server, and a control unit which carries out the server load control based on the operating plan when the matter-of-interest information or the time information satisfies an execution condition included in the operating plan.

This application is based upon and claims the benefit of priority from Japanese Patent Application No. 2014-185981, filed on Sep. 12, 2014, the disclosure of which is incorporated herein in its entirety by reference.

### TECHNICAL FIELD

The present invention relates to a technique of performing automatic scaling based on accumulated information in a Web-based system.

### BACKGROUND ART

In recent years, configuring a system model using a cloud computing technology has been increasing. Such a system is constituted of multitudes of server machines. Further, it is often the case that application layers constituting these server machines have the same configuration as each other.

Recently, in a Web-based system, when the load of a Web application server increases, generally, tuning a relevant parameter is performed, or the system is scaled out in response to the tuning.

There are a variety of causes which increase the load of a Web application server. For instance, when beyond an estimated amount requests are concurrently issued to a Web application server, the load of the Web application server increases. In such a case, it is possible to solve the problem by tuning a relevant parameter, because insufficient tuning is a cause of an increase in load.

However, when a Web site has a strong correlation between a degree of interest among the people and the contents, such as a shopping site, a video posting site, or an auction site; and the load of a Web application server increases or decreases, as the degree of interest changes, it is difficult to flexibly handle the increase or the decrease of the load, unless the tendency of the increase or the decrease is estimated.

Further, a huge amount of labor is required for the estimation, in addition to technical or experienced analysis skills. Thus, it is difficult to implement the estimation.

As a general approach for a load distributing system, in which the estimation is difficult, there is proposed a method such that the system is scaled in or scaled out. In this method, a monitoring system measures a load status of a Web application server or a load status of a machine in which the server is operated. When a load in excess of a predetermined threshold value is detected, the number of Web application servers in operation is automatically increased or decreased.

In a cloud service system, which is becoming a mainstream in recent years, however, the following drawbacks may occur in the aspect of operation when the aforementioned method is employed. Specifically, the drawbacks are (1) limit of automatic scaling based on monitoring a threshold value, and (2) lack of consideration of a warm-up period of a server machine.

In the following, the aforementioned drawbacks (1) and (2) are described in detail. First of all, the drawback (1) is described. In a cloud service system, in many cases, a meter rate charging system is employed. Therefore, the cost increases according to an increase in consumption of machine resources such as a CPU (Central Processing Unit) and a memory increases. When scale-in or scale-out based on monitoring a threshold value as described above is performed, in a system in which an increase or a decrease in the request amount is large, addition/deletion of a server machine is frequently performed. This permits sharply increase of the consumption of machine resources. Thus, as the consumption of machine resources increases, the cost may also increase.

Next, the drawback (2) is described. It is often the case that the processing of adding a server machine for scale-out in a cloud service is not quickly performed even in a major service. Specifically, the processing of adding a server machine requires a predetermined warm-up period (several minutes to several ten minutes depending on a system configuration), as the processing of activating a server is performed.

The server machine cannot exhibit the inherent processing performance during the warm-up period. Therefore, the warm-up period may also be regarded as a loss time resulting from automatic scaling. In view of the above, when automatic scaling is performed in response to detection of server load, the system may be incapable of handling a sudden increase in load. On the other hand, if the system is always operated continuously by server machines of the maximum possible number, charging may be carried out for redundant system resources.

In view of the above problems, Japanese Patent Application Laid-open Publication No. 2011-090594 discloses a method, in which a degree of similarity of load fluctuation between a plurality of cluster systems is derived from load information collected in the past, and the necessity of scale-out is judged from the collected load information.

Further, Japanese Patent Application Laid-open Publication No. 2005-141441 discloses a method, in which access logs are read, and the required number of servers is estimated by a statistical method based on e.g. a time or days of the week for generating a server operating plan.

The method disclosed in Japanese Patent Application Laid-open Publication No. 2011-090594 is advantageous when load fluctuation has a causal relationship to a time. However, the method does not take into account a relationship between contents and load fluctuation, which is required to be considered in keywords relating to popular commodities included in Web contents, and in specific streaming videos whose number of times of browsing is large. Thus, for instance, there is a problem that the aforementioned method may be incapable of flexibly handling load fluctuation resulting from the trends or a degree of interest among the people.

As well as the aforementioned case, the method disclosed in Japanese Patent Application Laid-open Publication No. 2005-141441 does not take into account the relationship between contents and load fluctuation.

### SUMMARY

The present invention has been made in view of the above problem, and its main object is to provide a monitoring device which enables to carry out server load control, taking into consideration the relationship between contents and load fluctuation.

A monitoring device according to a first aspect of the present invention is configured to monitor one or more servers which perform a processing in response to a request from a client, and transmit a reply to the client. The monitoring device includes an operating plan unit which generates an operating plan of carrying out server load control depending on matter-of-interest information or depending on time information, based on access information related to the request and based on a request analysis result obtained by analyzing the request, the access information and the request analysis result being collected from the server, and a control unit which carries out the server load control based on the operating plan when the matter-of-interest information or the time information satisfies an execution condition included in the operating plan.

A server according to a first aspect of the present invention is configured to perform a processing in response to a request from a client, and transmit a reply to the client. The server includes a statistical unit which extracts matter-of-interest information from a request analysis result obtained by analyzing the request, and calculates a degree of interest with respect to the matter-of-interest information, based on access information related to the request, and a transmitting unit which transmits the degree of interest calculated by the statistical unit with respect to the matter-of-interest information to a monitoring device configured to monitor the server via a network.

A monitoring system according to a first aspect of the present invention is provided with one or more servers configured to perform a processing in response to a request from a client, and transmit a reply to the client, and a monitoring device configured to monitor the server. The server includes a statistical unit which extracts matter-of-interest information from a request analysis result obtained by analyzing the request, and calculates a degree of interest with respect to the matter-of-interest information, based on access information related to the request, and a transmitting unit which transmits the degree of interest calculated by the statistical unit with respect to the matter-of-interest information to the monitoring device. The monitoring device includes an operating plan unit which generates an operating plan of carrying out server load control depending on the matter-of-interest information or depending on time information, based on the access information and based on the request analysis result, the access information and the request analysis result being collected from the server, and a control unit which carries out the server load control based on the operating plan when the matter-of-interest information or the time information satisfies an execution condition included in the operating plan.

A monitoring method according to a first aspect of the present invention monitoring one or more servers configured to perform a processing in response to a request from a client, and transmit a reply to the client. The monitoring method includes generating an operating plan of carrying out server load control depending on matter-of-interest information or depending on time information, based on access information related to the request and based on a request analysis result obtained by analyzing the request, the access information and the request analysis result being collected from the server, and carrying out the server load control based on the operating plan when the matter-of-interest information or the time information satisfies an execution condition included in the operating plan.

The aforementioned object is also accomplished by a computer program which causes a computer to implement a monitoring method having the aforementioned configurations, and a computer-readable storage medium storing the computer program.

The invention of the present application is advantageous in carrying out server load control in the light of the relationship between contents and load fluctuation.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration of an information processing system in a first exemplary embodiment of the invention,

FIG. 2 is a block diagram illustrating a detailed configuration of a server machine and a system monitoring device provided in the information processing system in the first exemplary embodiment of the invention,

FIG. 3 is a flowchart illustrating an operation of receiving a request in an application server of a server machine in the first exemplary embodiment of the invention,

FIG. 4 is a flowchart illustrating an operation of analyzing request data in an application server of a server machine in the first exemplary embodiment of the invention,

FIG. 5 is a flowchart illustrating an operation of generating operating conditions by the system monitoring device in the first exemplary embodiment of the invention,

FIG. 6 is a flowchart illustrating an operation of deriving a correlation in generating operating conditions by the system monitoring device in the first exemplary embodiment of the invention,

FIG. 7 is a diagram illustrating an example of operating conditions to be generated by the system monitoring device in the first exemplary embodiment of the invention,

FIG. 8 is a diagram illustrating an example of monitoring information to be generated by an application server in the first exemplary embodiment of the invention,

FIG. 9 is a first half of a flowchart illustrating an operation of determining whether or not scaling by the system monitoring device in the first exemplary embodiment of the invention is necessary,

FIG. 10 is a second half of the flowchart illustrating the operation of determining whether or not scaling by the system monitoring device in the first exemplary embodiment of the invention is necessary,

FIG. 11 is a diagram illustrating a configuration of an information processing system in a second exemplary embodiment of the invention, and

FIG. 12 is a diagram exemplarily illustrating a hardware configuration of a device in each of the exemplary embodiments of the invention.

### EXEMPLARY EMBODIMENT

In the following, exemplary embodiments of the invention are described in detail referring to the drawings.

### First Exemplary Embodiment

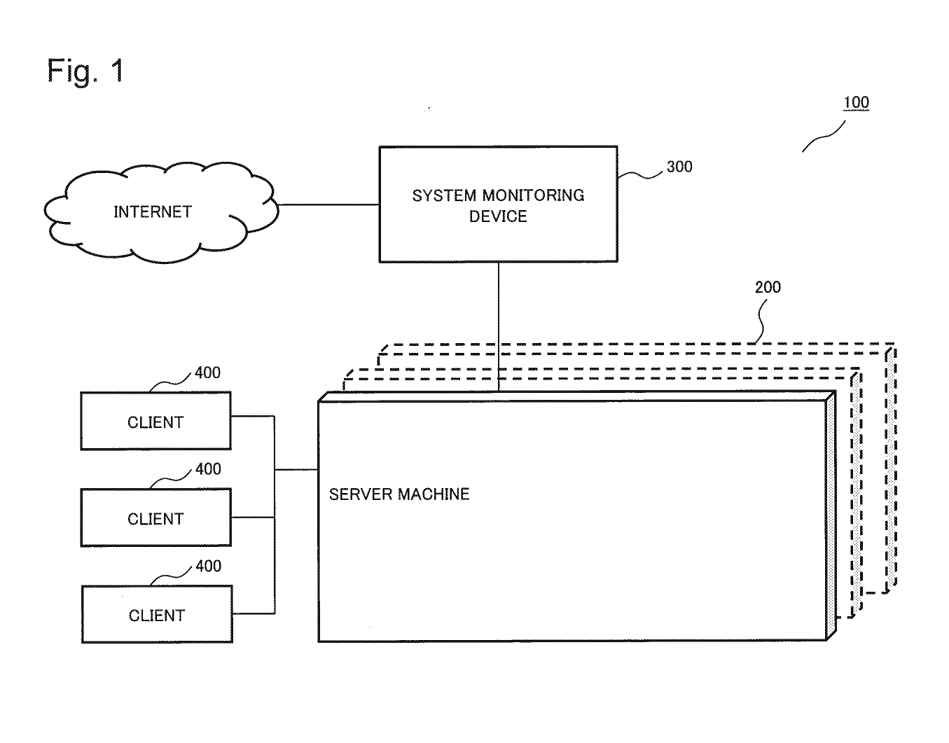

FIG. 1 is a diagram illustrating a configuration of an information processing system 100 in the first exemplary embodiment of the invention. As illustrated in FIG. 1, the information processing system 100 is provided with server machines 200, a system monitoring device 300, and clients (client apparatus) 400.

The server machines 200 operate a Web-based system for business use, and receive an access from the clients 400 to be used by the users. The Web-based system is constituted of two or more server machines 200. The server machines 200 may be physical servers or virtual servers.

The system monitoring device 300 integrally monitors the server machines 200. The system monitoring device 300 is connected to the Internet. The clients 400 are loaded with a client application such as a browser utilizing a Web-based system.

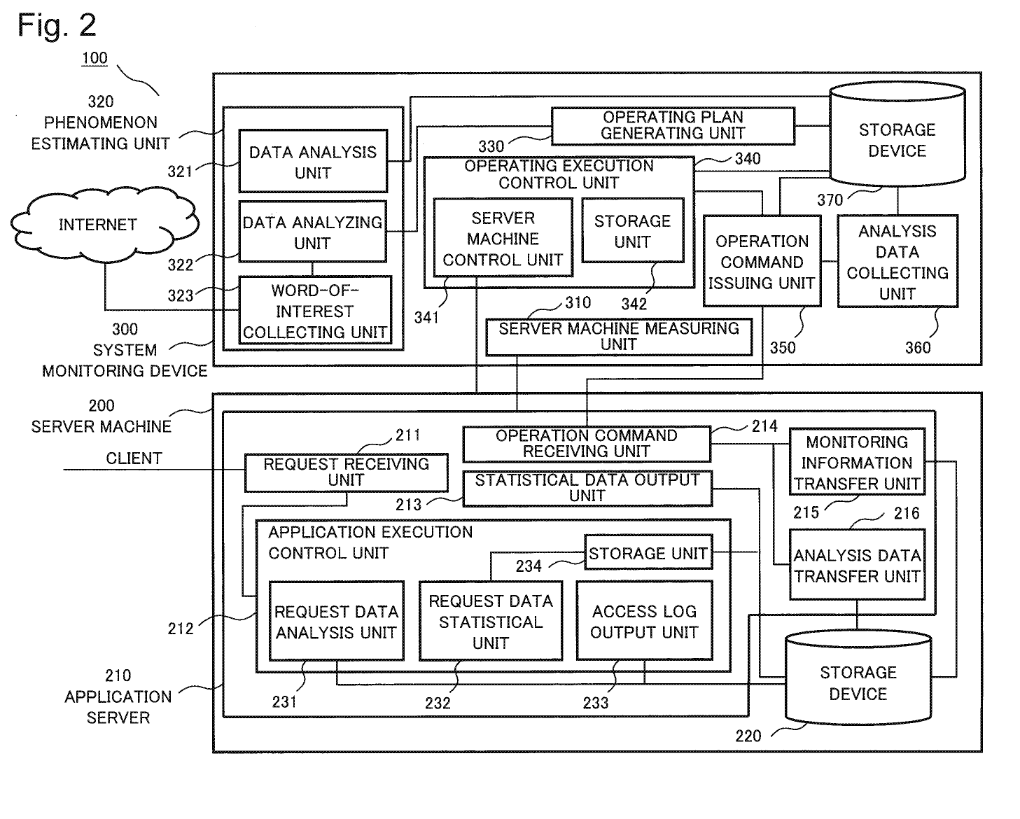

FIG. 2 is a block diagram illustrating a detailed configuration of the server machine 200 and the system monitoring device 300 illustrated in FIG. 1. FIG. 2 illustrates one of the server machines 200 configuring a Web-based system.

As illustrated in FIG. 2, the server machine 200 is loaded with an application server 210, based on which various applications to be operated in a Web-based system are executed.

The application server 210 is provided with a request receiving unit 211, an application execution control unit 212, a statistical data output unit 213, an operation command receiving unit (transmitting means) 214, a monitoring information transfer unit 215, and an analysis data transfer unit 216.

Further, the server machine 200 is provided with a storage device 220.

As illustrated in FIG. 2, the system monitoring device 300 for monitoring the server machine 200 is provided with a server machine measuring unit (server measuring means) 310, a phenomenon estimating unit 320, an operating plan generating unit 330, an operating execution control unit 340, an operation command issuing unit 350, an analysis data collecting unit 360, and a storage device 370.

Next, an outline of each of the constituent elements of the application server 210 is described.

The request receiving unit 211 receives a request from a system user, which is transmitted via a client application. The application execution control unit 212 performs an application logic related to the request. The statistical data output unit 213 outputs, to a file, execution information such as the number of request processings to be performed in the application server 210. The operation command receiving unit 214 receives an operation command from an external device with respect to the application server 210.

The monitoring information transfer unit 215 inserts information being monitored in the application server 210 into a result of calling an operation command from the external device. The analysis data transfer unit 216 inserts request data, access logs, and statistical data output from the application server 210 into the result of calling an operation command from the external device.

Next, a configuration of the application execution control unit 212 is described.

The application execution control unit 212 is provided with a request data analysis unit 231, a request data statistical unit (statistical means) 232, an access log output unit 233, and a storage unit 234.

The request data analysis unit 231 analyzes parameter information included in a request from a system user. The request data statistical unit 232 performs a statistical operation of the parameter information included in the request. The access log output unit 233 outputs access information related to the request (such as a time, a URL (Uniform Resource Locator), and an execution result) to a log file. The storage unit 234 stores various data relating to the statistical processing by the request data statistical unit 232.

The storage device 220 stores request data, access logs, and statistical data output from the application server 210.

Next, an outline of each of the constituent elements of the system monitoring device 300 is described.

The server machine measuring unit 310 measures the number of server machines 200 in operation, or a warm-up (initialization) period required for activation processing. The phenomenon estimating unit 320 estimates a scaling condition of server machines. The operating plan generating unit 330 defines operating conditions (an operating plan), based on the scaling condition of server machines, which is estimated and analyzed by a data analyzing unit 322. The operating execution control unit 340 controls the operation of server machines in accordance with the operating conditions generated by the operating plan generating unit 330.

The operation command issuing unit 350 issues an operation command to the application server 210 in the server machine 200 in accordance with an instruction from the operating execution control unit 340. The analysis data collecting unit 360 collects request data, access logs, and statistical data output from the application server 210 in the server machine. The storage device 370 stores the data collected by the analysis data collecting unit 360, and the operating conditions generated by the operating plan generating unit 330.

Next, a configuration of the phenomenon estimating unit 320 provided in the system monitoring device 300 is described. The phenomenon estimating unit 320 is provided with a data analysis unit 321, the data analyzing unit 322, and a word-of-interest collecting unit 323.

The data analysis unit 321 analyzes a data structure collected from the server machine 200. The data analyzing unit 322 estimates and analyzes the load status and the appropriate number of server machines in a Web-based system in the future, based on the data structure analyzed by the data analysis unit 321. The word-of-interest collecting unit 323 collects keywords of objects of current interest such as commodities or persons from a major information retrieval site such as Google (registered trademark) via the Internet.

Next, the operating execution control unit 340 is described in detail. The operating execution control unit 340 is provided with a server machine control unit 341 and a storage unit 342. The server machine control unit 341 controls server machines in accordance with the operating conditions. The storage unit 342 stores temporary data necessary for the control.

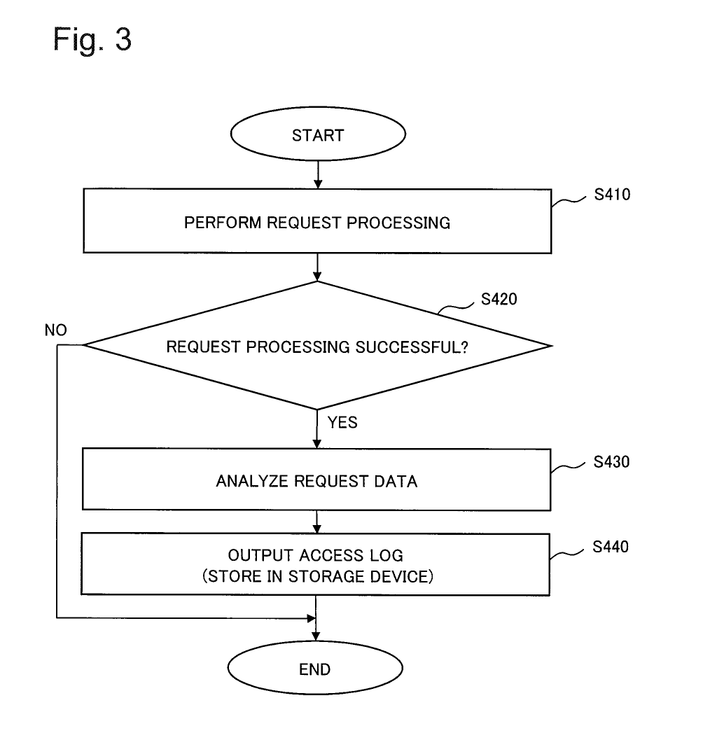

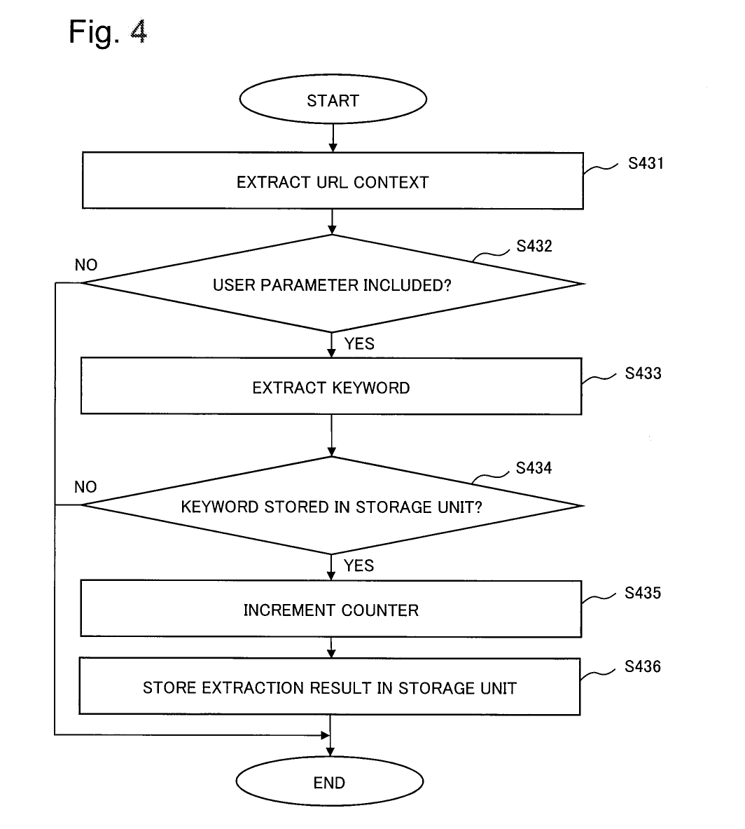

FIG. 3 and FIG. 4 are flowcharts illustrating an operation of receiving a request in the application server 210 of the server machine 200. The operation of receiving a request in the application server 210 is described referring to FIG. 3 and FIG. 4.

The application server 210 to be operated in each of the server machines 200 receives a request from a client application to be loaded in a client 400 by the request receiving unit 211. The request receiving unit 211 provides a request parameter (hereinafter, also called as “request data”) included in the received request to the application execution control unit 212.

The application execution control unit 212 calls a job processing related to a request parameter, and performs the processing (Step S410). When the job processing is normally finished (Yes in Step S420), the request data analysis unit 231 in the application execution control unit 212 analyzes the request data (Step S430).

FIG. 4 is a flowchart illustrating an operation of analyzing request data by the request data analysis unit 231, which is illustrated in Step S430 of FIG. 3. As illustrated in FIG. 4, the request data analysis unit 231 extracts a URL (Uniform Resource Locator) context related to a request (Step S431). When request data includes a user parameter (Yes in Step S432), the request data analysis unit 231 extracts a keyword in the user parameter (Step S433). The user parameter is optional data included in “GET” or “POST” when HTTP (Hypertext Transfer Protocol) is used as a communication protocol.

When the extracted URL context or keyword is stored in the storage unit 234 (Yes in Step S434), the request data statistical unit 232 increments a counter stored in the storage unit 234 (Step S435), which will be described later in detail. The request data analysis unit 231 and the request data statistical unit 232 store the analysis result as described above in the storage device 220 and in the storage unit 234.

Thereafter, as illustrated in FIG. 3, the access log output unit 233 in the application execution control unit 212 stores an access log relating to the request in the storage device 220 (Step S440). Subsequently, the application execution control unit 212 returns response data to the client application.

Analysis of request data and output of access logs may not be necessarily performed sequentially, but may be performed concurrently, in the light of the performance. Further, in the exemplary embodiment, the format for use in storing a request analysis result in the storage device 220 is not limited, and any format may be used.

The aforementioned sequence of steps are executed by a process to be operated by the application server 210 or by a thread of the process with respect to each of the requests.

Repeatedly performing the aforementioned processings on operating the Web-based system makes it possible to accumulate analysis data obtained by analyzing request data and access logs in the storage device 220 of the server machine 200.

Further, the application server 210 causes the statistical data output unit 213 to periodically store statistical data in the storage device 220, as performance information with respect to the functions constituting the internal structure of the application server 210. The statistical data includes measurement data such as memory consumption in a process, and the number of worker threads which process a request from a client.

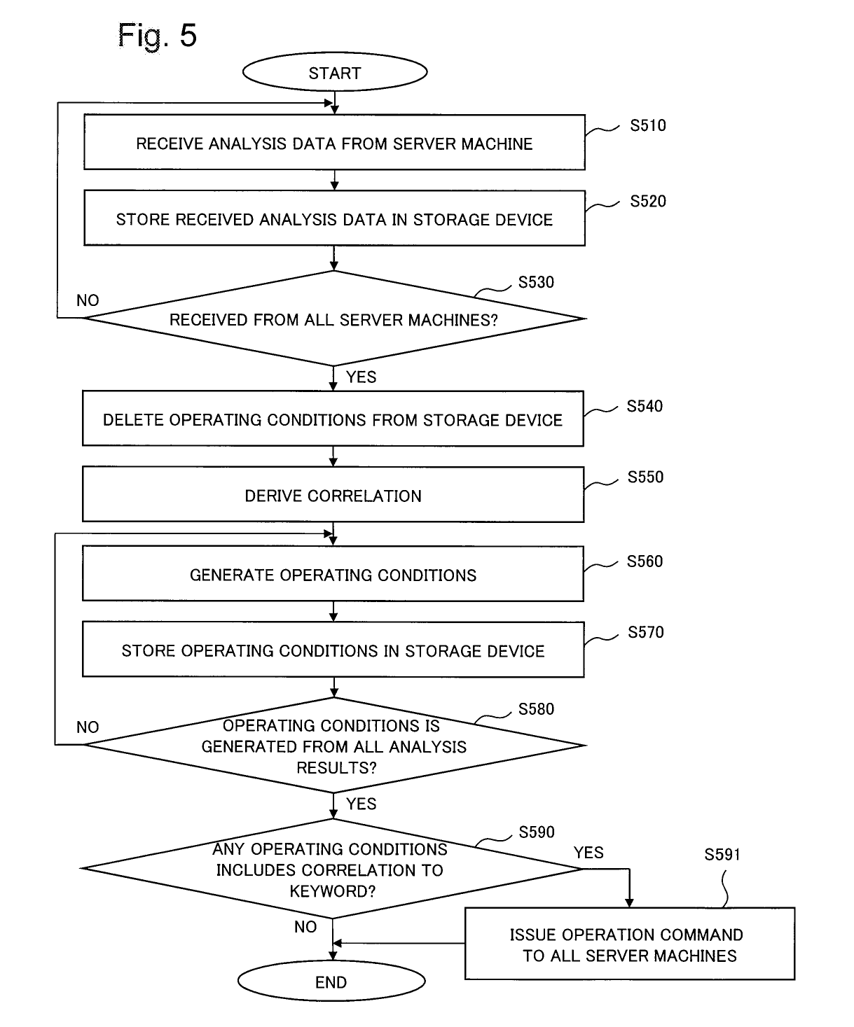

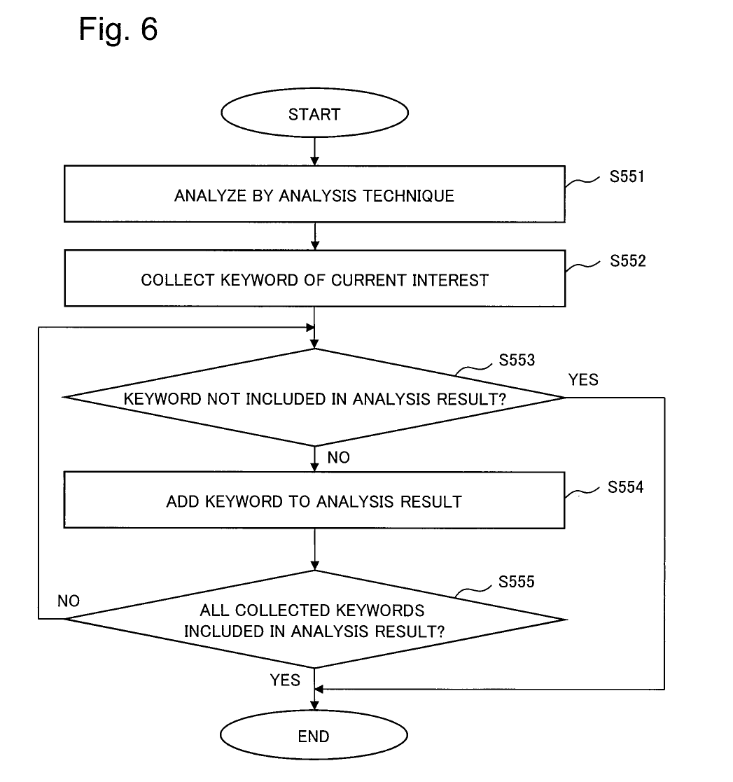

Next, an operation of the system monitoring device 300 is described referring to FIG. 5 and FIG. 6.

First of all, the assumptions relating to the system monitoring device 300 are described. The system monitoring device 300 appropriately manages the information relating to the configuration of the distributed application servers 210 by operative work of a system operator in advance. Further, the system monitoring device 300 is capable of issuing a required operation command to the server machines 200 under the control of the system monitoring device 300, and to the application servers 210 operated in the server machines 200 via a network.

Further, the following information is stored in advance in the storage device 370 provided in the system monitoring device 300, or is stored by a system operator. Specifically, the information is data capable of recognizing a change in access logs, statistical data, and the number of server machines including an operation result of a business system in the past; and a typical initial operating plan for automatic scaling. The initial operating plan is a definition relating to operating conditions such as “the system is scaled out when the CPU usage rate exceeds a predetermined value”.

Further, the server machine measuring unit 310 in the system monitoring device 300 measures the operating number of server machines 200 to be managed, and a time required for processing of activating each of the server machines 200. It is assumed that the operating number and the times are stored in the storage device 370.

An operation of generating operating conditions by the system monitoring device 300 is described referring to FIG. 5 and FIG. 6, based on the aforementioned assumptions.

The analysis data collecting unit 360 in the system monitoring device 300 issues an operation command to the operation command issuing unit 350 at a timing (e.g. every one hour) set by the system operator in advance. The operation command is a command to collect analysis data on request data, statistical data, and access logs from each of the server machines 200.

The operation command is received by the operation command receiving unit 214 in the application server 210 of each of the server machines 200. The operation command receiving unit 214 transfers the operation command to the analysis data transfer unit 216. The analysis data transfer unit 216 collects, from the storage device 220, the analysis data on request data, the statistical data, and the access logs generated by the application server 210 in response to the received operation command; and returns the collected analysis data etc. to the operation command receiving unit 214. The operation command receiving unit 214 returns the received analysis data etc. to the system monitoring device 300. The system monitoring device 300 receives the analysis data etc. by the operation command issuing unit 350 (Step S510). The operation command issuing unit 350 stores the received analysis data in the storage device 370 (Step S520). The system monitoring device 300 performs the processings of Step S510 and S520 with respect to all the server machines (Step S530).

After performing the aforementioned processing, the operation command issuing unit 350 deletes the analysis result (operating conditions) that has been stored in the storage device 370 last time (Step S540).

Subsequently, the phenomenon estimating unit 320 in the system monitoring device 300 reads out the data to be analyzed from the storage device 370. The data analysis unit 321 analyzes the necessary data, and transfers the analysis result to the data analyzing unit 322. The data analyzing unit 322 derives a correlation between the data by an existing data analysis technique (Step S550).

FIG. 6 is a flowchart illustrating an operation of deriving a correlation by the phenomenon estimating unit 320. As illustrated in FIG. 6, first of all, the data analyzing unit 322 analyzes data (Step S551). In particular, the data analyzing unit 322 analyzes data from the following viewpoint in deriving a correlation.

(i) a relationship with respect to the number of server machines to be operated for a specific period (e.g. a relationship between a weekday, a holiday, a specific day, or a specific day of the week; and the number of server machines to be operated during these periods)

(ii) a relationship between a specific keyword and the number of server machines to be operated (e.g. a condition such that when a keyword “XXX” is included, server machines of the number K are operated and the like)

(iii) a relationship between a specific URL context and the number of server machines to be operated (e.g. a condition such that when a Web page under the URL context “jpn.nec.com/xxx/” is accessed, server machines of the number L are operated and the like)

Any means for deriving the analysis result as described above is arbitrarily applicable.

Next, the word-of-interest collecting unit 323 in the phenomenon estimating unit 320 collects keywords whose degree of interest is high among the people, utilizing a service to be provided by an information retrieval site such as Google Trends, or a relevant API (Application Programming Interface) via the Internet (Step S552). When there is a keyword that is not included in the aforementioned analysis result with respect to the collected keywords (No in Step S553), the phenomenon estimating unit 320 adds the keyword to the analysis result (Step S554). The phenomenon estimating unit 320 performs the processings of Step S553 and Step S554 until all the collected keywords are included in the analysis result (Step S555).

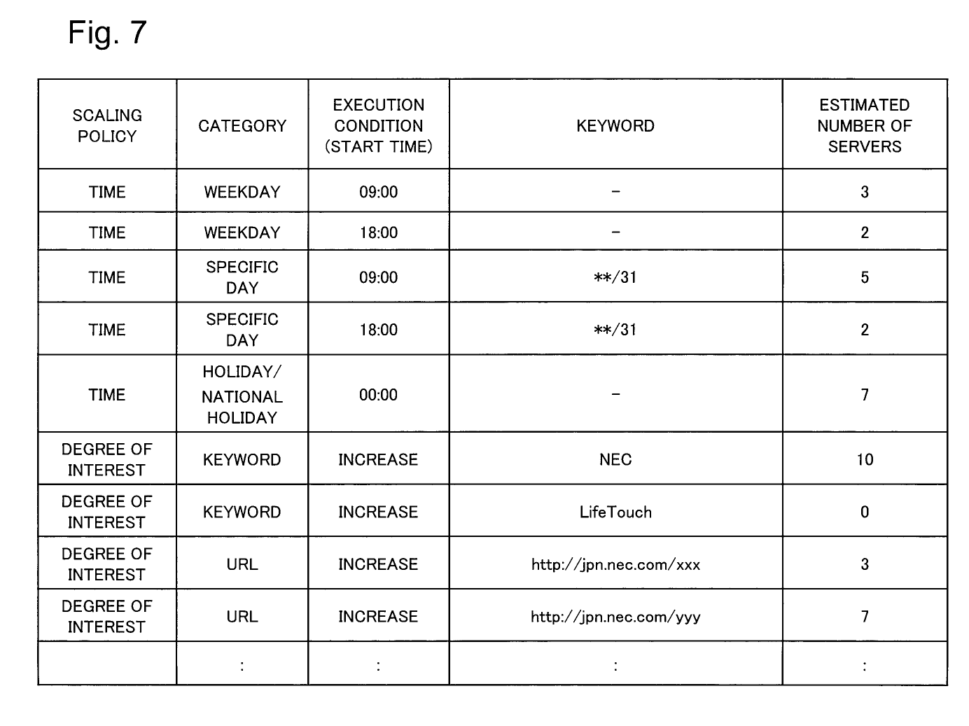

Subsequently, as illustrated in FIG. 5, the operating plan generating unit 330 in the system monitoring device 300 generates operating conditions as illustrated in FIG. 7, based on the aforementioned analysis result obtained by the data analyzing unit 322 (Step S560), and stores the generated operating conditions in the storage device 370 (Step S570).

FIG. 7 is a diagram illustrating an example of operating conditions generated by the operating plan generating unit 330. As illustrated in FIG. 7, the operating conditions include “scaling policy”, “category”, “execution condition”, “keyword”, and “the estimated number of servers”. “Scaling policy” indicates an index for performing scaling, such as a time or a degree of interest. “Category” is information indicating classification of scaling policies. For instance, when the scaling policy is a time, “category” is a weekday, a specific day, or the like. When the scaling policy is a degree of interest, “category” is a keyword, a URL, or the like.

“Execution condition” is a condition (a trigger) for performing scaling, and is a condition such as a start time at which scaling is performed, a phenomenon such that the number of accesses (a degree of interest) to a keyword or a URL tends to increase, or the like. “Keyword” is information serving as a key to the contents, such as information relating to a date, a phrase included in the contents, a URL to be designated by a user request, or the like. “The estimated number of servers” is an estimated value of the required number of servers in a state that each of the aforementioned conditions included in the operating conditions is satisfied. The required number of servers is estimated by the data analyzing unit 322, based on the aforementioned analysis result, access logs, or the like.

The operating plan generating unit 330 generates the aforementioned operating conditions from all the analysis results obtained by the data analyzing unit 322 (Step S580).

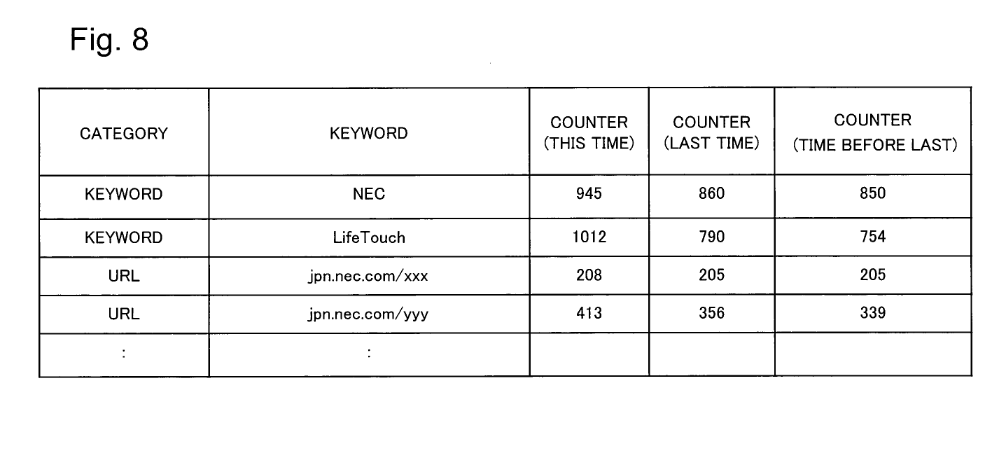

Further, when the generated operating conditions include an operating condition such that a correlation between a specific keyword and the estimated number of servers is included (Yes in Step S590), the operation command issuing unit 350 issues the following operation command to each of the server machines 200 (Step S591). Specifically, the operation command issuing unit 350 issues, to each of the server machines 200, an operation command to include keyword information to be monitored in the storage unit 234 of the application server 210. When the aforementioned operation is performed, monitoring information as illustrated in FIG. 8 is stored in the storage unit 234.

FIG. 8 is a diagram illustrating an example of monitoring information. As illustrated in FIG. 8, the monitoring information includes “category”, “keyword”, “counter (this time)”, “counter (last time)”, and “counter (time before last)”. “Category” and “keyword” are the same as “category” and “keyword” included in the aforementioned operating conditions. “Counter (this time)”, “counter (last time)”, and “counter (time before last)” are the numbers of accesses with a keyword included in the monitoring information illustrated in FIG. 8, and respectively hold the numbers of accesses at a monitoring timing of this time, last time, and time before last.

The system monitoring device 300 generates the operating conditions by the aforementioned processings.

Next, an operation of scaling to be performed by the system monitoring device 300 is described.

The system monitoring device 300 causes the operating execution control unit 340 to read out the operating conditions from the storage device 370 at a periodical timing set by the system operator in advance (e.g. at every one minute). The operating execution control unit 340 determines whether or not it is necessary to perform scaling, and an optimum scaling condition (such as the required number of servers), based on the readout operating conditions. When the aforementioned operation is performed, the server machine control unit 341 controls the storage unit 342 to store a variable “the required number of servers”, which means the number of server machines to be operated from now; and initializes the value by “1”.

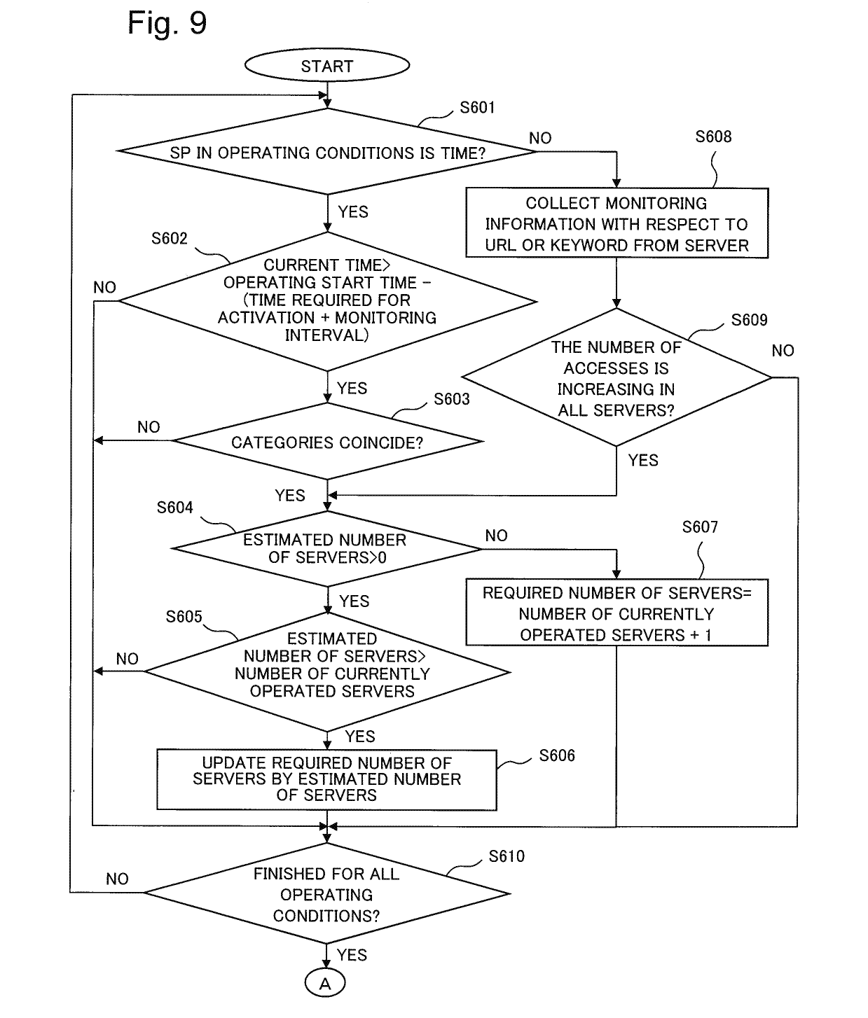

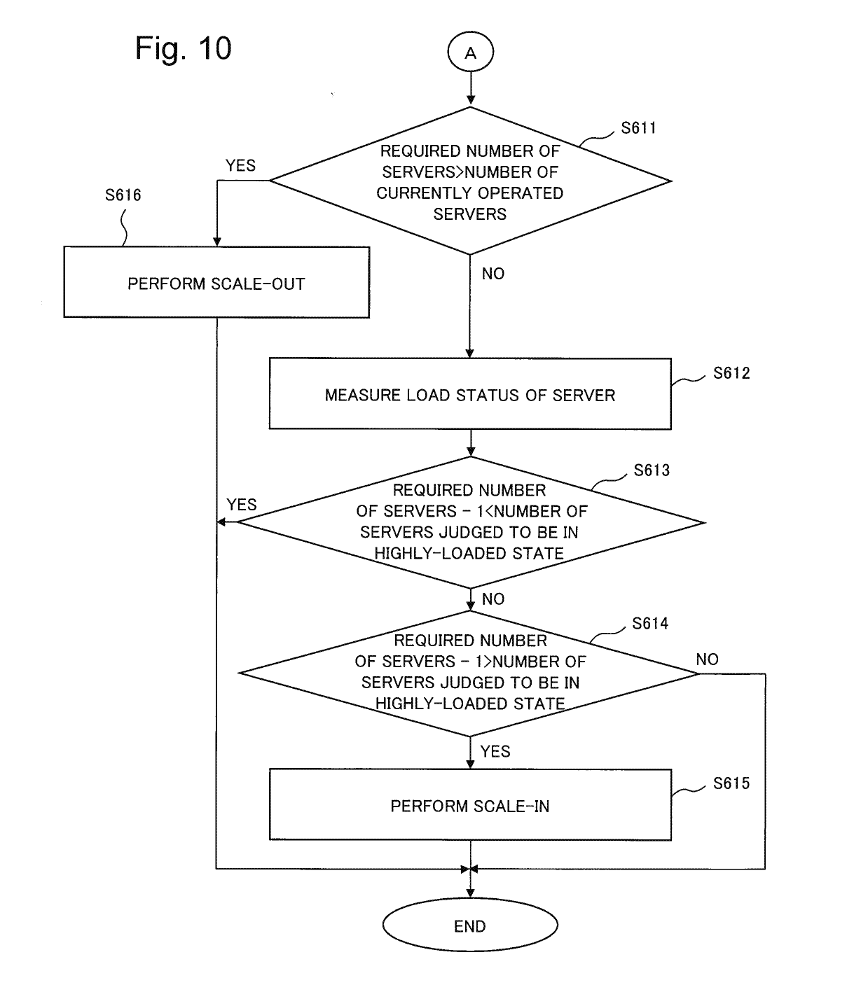

FIG. 9 and FIG. 10 are a flowchart illustrating an operation of scaling based on the operating conditions. The operation of scaling is described referring to FIG. 9 and FIG. 10.

The operating execution control unit 340 checks the operating conditions stored in the storage device 370, as illustrated in FIG. 7, one by one in determining an optimum condition. First of all, when the scaling policy (SP) included in the operating conditions is “time” (Yes in Step S601), the operating execution control unit 340 checks whether the current time reaches the time designated by the execution condition included in the operating conditions. More strictly, the operating execution control unit 340 checks whether the current time reaches the time obtained by subtracting a warm-up period (an activation period) required for processing of activating a server machine, and a constant monitoring time interval for use in determining an optimum scaling condition, from the designated time. This is in order to take into account a preparatory period of a server machine until the server machine is capable of executing a job.

When the current time reaches the aforementioned time (Yes in Step S602), the operating execution control unit 340 checks whether the category included in the operating conditions and the category represented by the current time coincide with each other by comparing the categories. When the categories coincide with each other (Yes in Step S603), comparison is made between the number of server machines in operation, which is obtained by the server machine measuring unit 310, and the estimated number of servers included in the operating conditions. When the estimated number of servers is larger than “0” (Yes in Step S604), the operating execution control unit 340 further compares the estimated number of servers and the number of currently operated server machines (Step S605). When the estimated number of servers is larger than the number of currently operated server machines (Yes in Step S605), the operating execution control unit 340 updates the variable “the required number of servers” by the estimated number of servers (Step S606).

On the other hand, when the estimated number of servers is “0” in Step S604 (No in Step S604), the operating execution control unit 340 updates the variable “the required number of servers” by the value obtained by adding “1” to the current number of servers (Step S607).

On the other hand, when the scaling policy included in the operating conditions is not “time” but “degree of interest” in Step S601 (No in Step S601), the operating execution control unit 340 collects the monitoring information with respect to a URL context or with respect to a keyword from each of the server machines as follows (Step S608).

Specifically, the operating execution control unit 340 requests the operation command issuing unit 350 to issue an operation command to collect monitoring information. The operation command issuing unit 350 transmits the operation command to collect the monitoring information to each of the server machines. Each of the server machines receives the operation command by the operation command receiving unit 214, and requests the monitoring information transfer unit 215 to transfer the monitoring information. In response to the request, the monitoring information transfer unit 215 reads out the monitoring information from the storage unit 234, and includes the readout monitoring information in a reply with respect to the operation command. The operation command receiving unit 214 transmits the reply including the monitoring information with respect to the operation command to the system monitoring device 300. The system monitoring device 300 receives the reply by the operation command issuing unit 350, and provides the reply to the operating execution control unit 340.

When it is determined that the number of accesses with a keyword included in the operating conditions is increasing in all the server machines, based on the acquired monitoring information (Yes in Step S609), the operating execution control unit 340 updates the variable “the required number of servers” by performing the same processings as in Step S604 to Step S606.

In the operating execution control unit 340, the increase of the number of accesses is not limited to be determined based on a tendency of increase, which is obtained from “counter (this time)”, “counter (last time)”, and “counter (time from last)” included in the monitoring information illustrated in FIG. 8. Specifically, the operating execution control unit 340 may check whether the number of accesses is increasing, using e.g. a quadratic function.

The operating execution control unit 340 performs the processings from Step S601 to Step S609 with respect to all the operating conditions stored in the storage device 370 (Step S610).

Subsequently, when the variable “the required number of servers” exceeds the number of currently operated server machines (Yes in Step S611 in FIG. 10), the operating execution control unit 340 causes the server machine control unit 341 to perform scale-out processing for additionally activating server machines of the number equal to the difference between the required number of servers and the number of currently operated server machines (Step S616). On the other hand, when the variable “the required number of servers” is equal to or smaller than the number of currently operated server machines, the operating execution control unit 340 measures a load status of each of the server machines (Step S612). The operating execution control unit 340 judges the load statuses, based on a condition included in the aforementioned typical initial operating plan for automatic scaling. Specifically, the operating execution control unit 340 judges that the server is in a highly-loaded state when the server satisfies a condition included in the initial operating plan. For example, the operating execution control unit 340 judges that the server is in a highly-loaded state when more than a predetermined load is applied on the server.

The operating execution control unit 340 compares the number of servers which are judged to be in a highly-loaded state, and a value obtained by subtracting “1” from the variable “the required number of servers”. When the former number (that is, the number of servers which are judged to be in a highly loaded state) is larger (Yes in Step S613), the operating execution control unit 340 judges that the unexpected load that does not conform to the past operation result is applied, and scale-out processing is performed based on an actual operation by the server machine control unit 341 (Step S616). On the other hand, when the latter number (that is, a value obtained by subtracting “1” from the variable “the required number of servers”) is larger (Yes in Step S614), the operating execution control unit 340 causes the server machine control unit 341 to perform scale-in processing for stopping server machines of the number equal to the difference between the former number and the latter number (Step S615).

As described above, according to the first exemplary embodiment, the system monitoring device 300 analyzes a parameter included in a user request, and the like in receiving the request, and derives a relationship between the contents of a Web page or a specific Web page, and load fluctuation, using the analysis result. Then, the system monitoring device 300 generates an execution plan (an operating plan) on automatic scaling, based on the derived relationship. According to the first exemplary embodiment, employing the aforementioned configuration is advantageous in performing scaling in the light of a relationship between contents and load fluctuation, in other words, in the light of centralization of load to a specific page or to a specific server resulting from changes in fashion or trends among the people.

The system monitoring device 300 performs scaling in accordance with an operating plan. Therefore, according to the first exemplary embodiment, it is possible to perform automatic scaling. Thus, the first exemplary embodiment is advantageous in reducing the SI (System Integration) cost and the maintenance cost.

Further, the system monitoring device 300 measures in advance a warm-up (initialization) period until a server machine is usable, and controls to start scale-out processing in the light of the warm-up period. Thus, according to the first exemplary embodiment, it is possible to prevent performance degradation or an access error resulting from lack of preparation of scaling processing with respect to the time required for initialization of a server when the access is rapidly increased, for instance. Thus, the first exemplary embodiment is advantageous in preventing system failure due to high load resulting from a time required for activating a server machine.

### Second Exemplary Embodiment

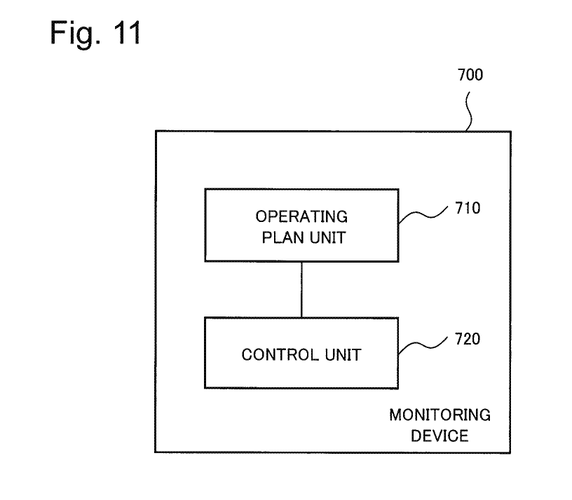

FIG. 11 is a diagram illustrating a configuration of a monitoring device 700 in the second exemplary embodiment of the invention. As illustrated in FIG. 11, the monitoring device 700 is provided with an operating plan unit 710 and a control unit 720.

The monitoring device 700 monitors one or more servers configured to perform a processing in response to a request from a client, and transmit a reply to the client.

The operating plan unit 710 generates an operating plan of carrying out server load control depending on matter-of-interest information (keyword) or depending on time information, based on access information related to a request and based on a request analysis result obtained by analyzing the request, which have been collected from the server.

The control unit 720 carries out the server load control based on the operating plan when the matter-of-interest information or the time information satisfies an execution condition included in the operating plan.

The operating plan unit 710 corresponds to the phenomenon estimating unit 320 and the operating plan generating unit 330 in the first exemplary embodiment; and the control unit 720 corresponds to the operating execution control unit 340 in the first exemplary embodiment.

According to the second exemplary embodiment, employing the aforementioned configuration is advantageous in carrying out server load control in the light of a relationship between contents and load fluctuation.

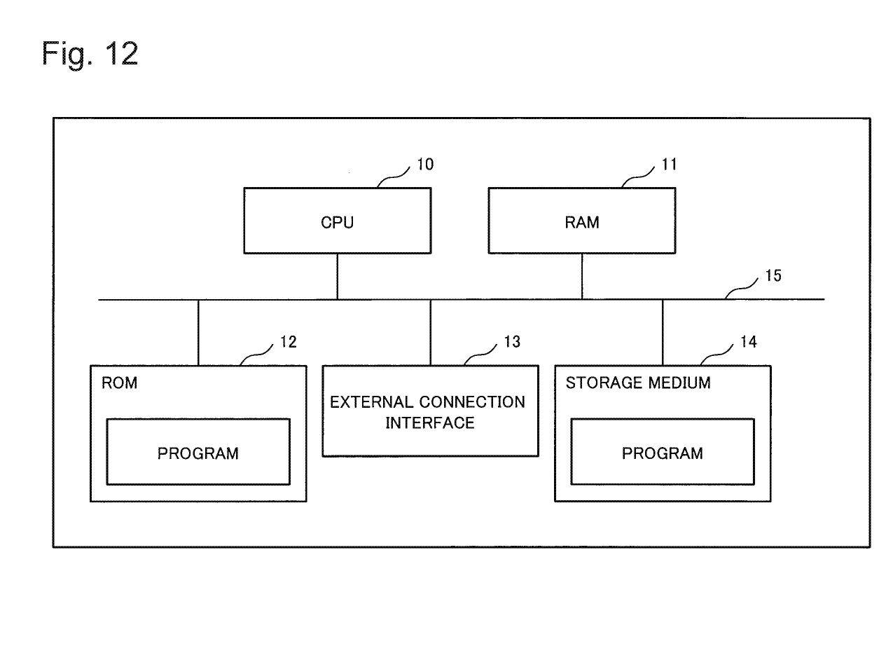

The respective units constituting the server machine and the system monitoring device illustrated in FIG. 2 etc. are implemented by hardware resources exemplarily illustrated in FIG. 12. Specifically, the configuration illustrated in FIG. 12 is provided with a CPU (Central Processing Unit) 10, an RAM (Random Access Memory) 11, an ROM (Read Only Memory) 12, an external connection interface 13, and a storage medium 14. The constituent elements are connected to each other by a bus 15. The CPU 10 controls the overall operation of the server machine and of the system monitoring device by reading out various software programs (computer programs) stored in the ROM 12 or in the storage medium 14 onto the RAM 11 for executing the programs. Specifically, in each of the exemplary embodiments, the CPU 10 executes software programs that execute the respective functions (respective units) provided in the server machine and in the system monitoring device, while referring to the ROM 12 or referring to the storage medium 14, as necessary.

Further, in each of the aforementioned exemplary embodiments, a case where the CPU 10 illustrated in FIG. 12 executes the functions represented by the respective blocks of the server machine and of the system monitoring device illustrated in FIG. 2 etc. by software programs has been described. However, a part or all of the functions represented by the respective blocks illustrated in FIG. 2 etc. may be implemented as hardware resources.

Further, the invention exemplarily described in each of the exemplary embodiments is accomplished by providing a computer program implementable of the aforementioned functions to a server machine and to a system monitoring device, and then, causing the CPU 10 to read out the computer program onto the RAM 11 for executing the computer program.

Further, the provided computer program may be stored in a readable and writable memory (a transitory storage medium) or in a computer-readable storage device such as a hard disk device. In the aforementioned configuration, the present invention may be construed as codes configuring the computer program, or as a storage medium in which the computer program is stored.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents. Further, it is noted that the inventor's intent is to retain all equivalents of the claimed invention even if the claims are amended during prosecution.

### REFERENCE SIGNS LIST

10 CPU
11 RAM
12 ROM
13 External connection interface
14 Storage medium
100 Information processing system
200 Server machine
210 Application server
211 Request receiving unit
212 Application execution control unit
213 Statistical data output unit
214 Operation command receiving unit
215 Monitoring information transfer unit
216 Analysis data transfer unit
220 Storage device
231 Request data analysis unit
232 Request data statistical unit
233 Access log output unit
234 Storage unit
300 System monitoring device
310 Server machine measuring unit
320 Phenomenon estimating unit
321 Data analysis unit
322 Data analyzing unit
323 Word-of-interest collecting unit
330 Operating plan generating unit
340 Operating execution control unit
341 Server machine control unit
342 Storage unit
350 Operation command issuing unit
360 Analysis data collecting unit
370 Storage device

1. A monitoring device configured to monitor one or more servers which perform a processing in response to a request from a client, and transmit a reply to the client, comprising:
an operating plan unit which generates an operating plan of carrying out server load control depending on matter-of-interest information or depending on time information, based on access information related to the request and based on a request analysis result obtained by analyzing the request, the access information and the request analysis result being collected from the server; and
a control unit which carries out the server load control based on the operating plan when the matter-of-interest information or the time information satisfies an execution condition included in the operating plan.

2. The monitoring device according to claim 1, further comprising:
a server measuring unit which measures a time required for activating the server, wherein
the control unit carries out the control when a time obtained by subtracting the time required for activating the server from a current time satisfies the execution condition.

3. The monitoring device according to claim 1, wherein
the operating plan unit derives at least one of a relationship between the matter-of-interest information and the number of servers in operation, and a relationship between the time information and the number of servers in operation, based on the access information and based on the request analysis result and estimates the required number of servers depending on the matter-of-interest information or depending on the time information, and generates the operating plan including the estimated number of servers.

4. The monitoring device according to claim 2, wherein
the operating plan unit derives at least one of a relationship between the matter-of-interest information and the number of servers in operation, and a relationship between the time information and the number of servers in operation, based on the access information and based on the request analysis result and estimates the required number of servers depending on the matter-of-interest information or depending on the time information, and generates the operating plan including the estimated number of servers.

5. The monitoring device according to claim 3, wherein
the control unit performs scale-out processing of the server when the number of servers in operation is smaller than the estimated number of servers included in the operating plan.

6. The monitoring device according to claim 4, wherein
the control unit performs scale-out processing of the server when the number of servers in operation is smaller than the estimated number of servers included in the operating plan.

7. The monitoring device according to claim 3, wherein
the control unit performs scale-in processing of the server when the number of servers in operation is larger than the estimated number of servers included in the operating plan, and the number of servers in operation to which more than a predetermined load is applied is smaller than the number obtained by subtracting one from the estimated number of servers.

8. The monitoring device according to claim 4, wherein
the control unit performs scale-in processing of the server when the number of servers in operation is larger than the estimated number of servers included in the operating plan, and the number of servers in operation to which more than a predetermined load is applied is smaller than the number obtained by subtracting one from the estimated number of servers.

9. The monitoring device according to claim 1, wherein
the operating plan unit sets a keyword included in the request from the client, as the matter-of-interest information.

10. The monitoring device according to claim 1, wherein
the operating plan unit extracts a keyword that satisfies a predetermined condition from an information retrieval site via a network, and sets the keyword as the matter-of-interest information.

11. The monitoring device according to claim 9, further comprising:
an operation command issuing unit which transmits the keyword to the one or more servers as an object to be monitored.

12. A server configured to perform a processing in response to a request from a client, and transmit a reply to the client, comprising:
a statistical unit which extracts matter-of-interest information from a request analysis result obtained by analyzing the request, and calculates a degree of interest with respect to the matter-of-interest information, based on access information related to the request; and
a transmitting unit which transmits the degree of interest calculated by the statistical unit with respect to the matter-of-interest information to a monitoring device configured to monitor the server via a network.

13. A monitoring system provided with one or more servers configured to perform a processing in response to a request from a client, and transmit a reply to the client, and a monitoring device configured to monitor the server, the server comprising:
a statistical unit which extracts matter-of-interest information from a request analysis result obtained by analyzing the request, and calculates a degree of interest with respect to the matter-of-interest information, based on access information related to the request; and
a transmitting unit which transmits the degree of interest calculated by the statistical unit with respect to the matter-of-interest information to the monitoring device, wherein
the monitoring device includes:
an operating plan unit which generates an operating plan of carrying out server load control depending on the matter-of-interest information or depending on time information, based on the access information and based on the request analysis result, the access information and the request analysis result being collected from the server; and
a control unit which carries out the server load control based on the operating plan when the matter-of-interest information or the time information satisfies an execution condition included in the operating plan.

14. A monitoring method monitoring one or more servers configured to perform a processing in response to a request from a client, and transmit a reply to the client, comprising:
generating an operating plan of carrying out server load control depending on matter-of-interest information or depending on time information, based on access information related to the request and based on a request analysis result obtained by analyzing the request, the access information and the request analysis result being collected from the server; and
carrying out the server load control based on the operating plan when the matter-of-interest information or the time information satisfies an execution condition included in the operating plan.

15. A non-transitory program recording medium storing a monitoring program of monitoring one or more servers configured to perform a processing in response to a request from a client, and transmit a reply to the client, the monitoring program causing a computer to execute:
a processing of generating an operating plan of carrying out server load control depending on matter-of-interest information or depending on time information, based on access information related to the request and based on a request analysis result obtained by analyzing the request, the access information and the request analysis result being collected from the server; and
a processing of carrying out the server load control based on the operating plan when the matter-of-interest information or the time information satisfies an execution condition included in the operating plan.
